(19) United States
(12) Patent Application Publication
(10) Pub. No.: US 2025/0121278 A1
(43) Pub. Date: Apr. 17, 2025

(54) SYSTEMS AND METHODS FOR OPTIMIZING A CONTROL SCHEME OF A GAME CONTROLLER

(71) Applicant: Sony Interactive Entertainment Inc., Tokyo (JP)

(72) Inventor: Jun Yen Leung, London (GB)

(73) Assignee: Sony Interactive Entertainment Inc., Tokyo (JP)

(21) Appl. No.: 18/907,646

(22) Filed: Oct. 7, 2024

(30) Foreign Application Priority Data
Oct. 12, 2023 (GB) 2315630.0

(51) Int. Cl. A63F 13/22; A63F 13/42; A63F 13/533; A63F 13/79; G06N 3/092

(52) U.S. Cl. CPC A63F 13/22; A63F 13/42; A63F 13/533; A63F 13/79; G06N 3/092

(57) ABSTRACT

A method for optimizing a control scheme of a game controller including a plurality of controls. The method comprises the steps of obtaining accessibility constraints corresponding to a user's accessibility needs; operating an artificial intelligence agent to play a computer game based on a plurality of candidate control schemes and conforming to the accessibility constraints; and determining the candidate control scheme that achieves a predetermined performance objective as an optimized control scheme.

### BACKGROUND OF THE INVENTION

### Field of the Invention

The present technique relates to systems and methods for optimizing accessibility control of a game controller.

### Description of the Prior Art

Recently, game controllers have been designed to implement features for aiding accessibility. These features include allowing players to personalize and configure the input devices according to their preferences and physical needs. For example, users can modify the function of buttons on the game controller, so that game commands can be executed through buttons that are more comfortable for the user to reach.

In addition, specialized input device commonly known as accessibility controllers are engineered to make video games more accessible to all players, regardless of their physical abilities. These controllers may include features like large buttons, customizable layouts and alternative input devices such as eye-tracking technology. Comparing to standard game controllers, accessibility controllers can further accommodate the special needs of players having limited hand dexterity, muscle weakness, or other physical limitations, so that they can enjoy video games alongside their peers. Nevertheless, the conventional game controllers tend to suffer from one or more of a multiplicity of drawbacks:

For conventional game controllers, the control configurations, or control schemes, such as button assignments for game actions, are provided by game developers as the default setting. These default control configurations are designed based on gameplay mechanics, user intuitiveness, and established industry standards. However, the control configuration design process is often based on the assumption that the player has full access of all controls on the game controller, while the special needs of players with physical limitations are usually neglected by game developers.

Even the player can later customize the control configuration by themselves, the configuration is mostly based on experiences and preferences of the user. The actual usability and utilization of the controls for playing a particular game cannot be verified by the user because the customized control configuration cannot be evaluated and adjusted through extensive playtesting. Without iterative testing of the customized control configuration, the user would not be able to optimize the control to provide the best accessibility and gameplay experience. Furthermore, the customization of the control configuration by the user is limited by the user's own experiences. However, in reality, there may be better modified control schemes available that haven't been thought of.

The present technique seeks to mitigate or alleviate some or all of the above-mentioned problems.

### SUMMARY OF THE INVENTION

Various aspects and features of the present technique are defined in the appended claims and within the text of the accompanying description.

In a first aspect, a method of optimizing a control scheme for a game controller including a plurality of controls, is provided in accordance with claim 1.

In another aspect, an information processing apparatus for optimizing a control scheme for a game controller including a plurality of controls is provided in accordance with claim 16.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic diagram of a video game system in accordance with embodiments of the present application;

FIG. 2 is a schematic diagram of an entertainment device in accordance with embodiments of the present application;

FIG. 3 schematically illustrates a controller for interfacing with the entertainment device in FIG. 2 in accordance with embodiments of the present application;

FIG. 4 schematically illustrates an access controller for interfacing with the entertainment device in FIG. 2 in accordance with embodiments of the present application;

FIG. 5 illustrates an example scenario of calibrating an optimized control scheme of a game controller in accordance with embodiments of the present application;

FIG. 6 illustrates another example scenario of providing an optimized control scheme for a game controller in accordance with embodiments of the present application;

FIG. 7 illustrates a further example scenario of providing an optimized control scheme for a game controller in accordance with embodiments of the present application;

FIG. 8 is a schematic flow diagram of a method of optimizing a control scheme of a game controller in accordance with embodiments of the present application;

FIG. 9 is a schematic flow diagram of an optimisation process in the method of optimizing a control scheme of a game controller in FIG. 8 in accordance with embodiments of the present application; and

FIG. 10 is a schematic flow diagram of another optimisation process in the method of optimizing a control scheme of a game controller in FIG. 8 in accordance with embodiments of the present application.

### DESCRIPTION OF THE EMBODIMENTS

A video game system and method are disclosed. In the following description, a number of specific details are presented in order to provide a thorough understanding of the embodiments of the present technique. It will be apparent, however, to a person skilled in the art that these specific details need not be employed to practice the present technique. Conversely, specific details known to the person skilled in the art are omitted for the purposes of clarity where appropriate.

Embodiments of the present description are applicable to a video game system involving a video game console, a development kit for such a system, or a video game system using dedicated hardware or a computer and suitable controllers. In the present application terms such as ‘user’ and ‘player’, ‘control’ and ‘input device’, ‘control scheme’ and ‘control configuration’ may be used interchangeably except where indicated otherwise.

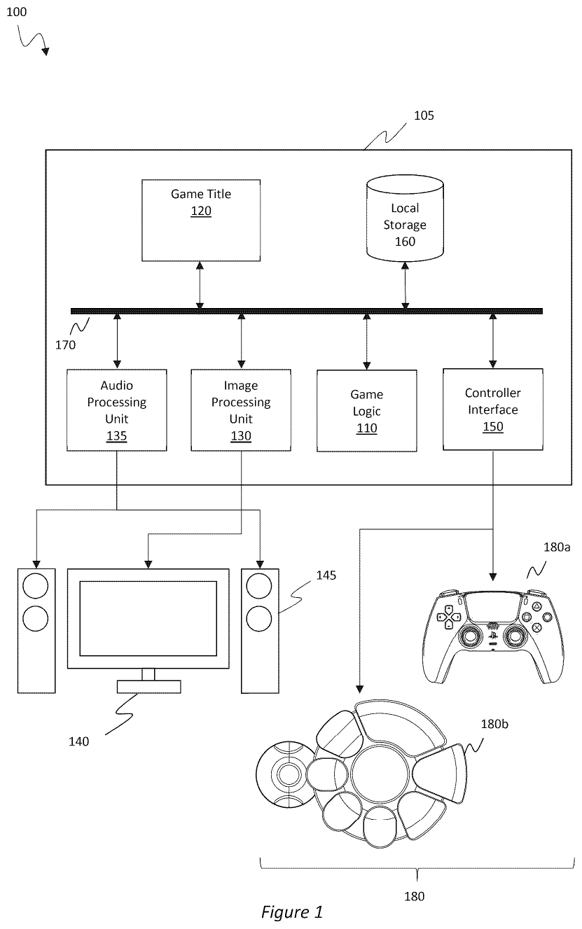

For the purposes of explanation and referring now to the drawings, wherein like reference numerals designate identical or corresponding parts throughout the several views, FIG. 1 illustrates a schematic diagram of a video game system 100 in accordance with embodiments of the present application. The video game system 100 may comprise a game console 105, a display device 140, a speaker system 145, and game controllers 180. In some cases such as for example portable game consoles, the display device 140, speaker system 145 and game controllers 180 may be integral to the video game system 100.

According to embodiments of the present application, the video game system 100 designs and optimizes the control schemes of game controllers by allowing an AI agent to play a game using a plurality of different candidate control schemes that conform to a particular constraint corresponding to a user's accessibility need. For example, if a user is only able to play games with his or her right hand, the AI agent will attempt to play the game using only the controls of the right hand side of a game controller. Similarly, if a user is only able to play games with their left hand, the AI agent will attempt to play the game using only the controls of the left hand side of the game controller. In another example, a user may be able to use both hands, but not be able to move one or more of their fingers or thumbs very quickly. In this case, the AI agent will attempt to play the game by modelling the effects of the accessibility constraints on the controls, such as applying a delay between repetitions of activating a given control (or given controls in a vicinity of each other) greater than a minimum threshold (e.g. 3 seconds). Similarly, the model may apply a delay between activations of two given controls depending on the proximity of the controls on the game controller.

During the optimization process, the AI agent tries to achieve one or more performance objectives such as maximising the game score (e.g. through reinforcement learning) using a plurality of candidate control configurations. Each candidate control configuration defines settings such as which control performs which game command. The performance of the AI agent also conforms to the accessibility constraints, which define parameters in relation to accessibility of the user, such as the delay in activating a given control, the minimum amount of time between repeated activations of a given control, and the minimum amount of time between activation of controls in the vicinity of each other. The candidate control configuration that achieves one or more predetermined performance objectives, such as enabling the highest game score over a predetermined time period, is then selected as the recommended control configuration.

The system and method for optimizing control configurations of game controller according to embodiments of the present application allows effective bespoke control configurations to be generated automatically for a given user with accessibility needs. For example, when a user with an accessibility need begins playing a game, he or she may choose to go through an accessibility “calibration” procedure which works out the appropriate constraints a control configuration used by the user must conform to (e.g. right hand controls only, no repeat button presses with a time of less than 3 seconds between repeats). The AI agent then attempts to play the game using a plurality of candidate control configurations (e.g. 10, 15 or 20), generated randomly or by iteration algorithms, which meet these accessibility constraints. The control configuration which allows the AI agent to attain one or more predetermined performance objectives such as obtaining a score higher than a predetermined threshold value, or achieving the best performance such as obtaining the maximum score for the game in a predetermined time period, is then recommended to the user.

Optionally or additionally, optimized control configurations and the corresponding accessibility constraints are store in a server such that the same optimized control configuration can be provided to another user for whom the same accessibility constraints apply. Therefore, for most players a control configuration will have already been discovered by previous optimization processes so that there is no delay in recommending an optimal control configuration to the user. Where a user is the first to enter a given accessibility constraint, then the system can tell them it will get back to them with a optimal control configuration later. Hence the optimization process could be applied at the developer level to generate preselectable control configurations based on accessibility information provided by an end-user during a “calibration” session or, if computing power allows, at the end-user level. In some embodiments, cloud computing resources are used to accelerate the reinforcement learning process of the optimal control configuration if necessary.

Applying the optimization process at the developer level results in higher speed for the end-user in generating the control configuration recommendation. This is because all the reinforcement learning has already been done and an appropriate control configuration is essentially selected “off the shelf”.

Applying the optimization process at the end-user level may result in a delay while the reinforcement learning is done, but may allow a control configuration which is bespoke to a particular user's needs to be generated.

According to embodiments of the present application, the video game system 100 provides a user interface on game controllers 180 which allows the user to receive information from the game controller regarding a specific input device on the game controller. In this case, the game console 105 accesses the game title database 120 and loads game data to initiate interactive gameplay. According to embodiments of the present application, game controllers 180 contains multiple input devices such as buttons and joysticks. Although FIG. 1 shows only a gamepad 180a and an access controller 180b as the game controllers, it is envisaged that embodiments of the present application are applicable to other types of game controllers such as steering wheels, paddles, flight sticks, light guns, keyboards and mouses.

Referring to the video game system 100 in FIG. 1, the game console 105 comprises a game logic 110, a game title database 120, an image processing unit 130, an audio processing unit 135, a game controller interface 150, and a local storage 160. The components of the game console 105 are connected via a bus 170.

The game logic 110 executes game code loaded from the game content storage of the game title database 120, in order to generate the game environment which interacts with the player character. The game logic 110 may also load user save data and user settings stored in local storage 160. The user may control the player character by operating the game controller 180, and the game logic 110 processes the input signals received from the game controller via the game controller interface 150. In some embodiments, the game logic 110 also executes an artificial intelligence agent to play the game in order to optimize the control scheme of the game controller 180.

The image processing unit 130 renders 2D or 3D computer graphics for the game environment and game feedbacks generated by the game logic 110. The image processing unit 130 then generates video signals for the game graphics, such as the game environment based on the player's perspective, and transmits the video signals to the display device 140.

Additionally, the audio processing unit 135 retrieves sound files and music files from the game title database 120 corresponding to the game environment and feedbacks generated by the game logic 110, then decompresses and decodes the files into audio signals for playback at the speaker system 145 to produce background music, character speech, audio tracks, sound effects of the game environment and the like.

Further, the controller interface 150 generates haptic feedback effects such as vibration on the game controllers 180a, 180b based on the game environment and game feedbacks generated by the game logic 110.

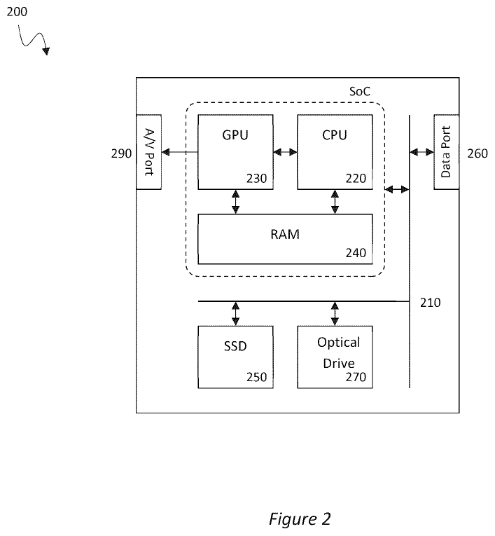

Further details of the video game console 105 will be described with reference to FIG. 2.

FIG. 2 schematically illustrates a schematic diagram of an entertainment device 200 in accordance with embodiments of the present application. The entertainment device 200 is a computer or games console and comprises a central processor 220. This may be a single or multi core processor, for example comprising eight cores. The entertainment device 200 also comprises a graphical processing unit or GPU 230. The GPU can be physically separate to the CPU, or integrated with the CPU as a system on a chip (SoC).

The entertainment device 200 also comprises RAM 240, and may either have separate RAM for each of the CPU and GPU, or shared RAM. The or each RAM can be physically separate, or integrated as part of an SoC. Further storage is provided by a disk 250, either as an external or internal hard drive, or as an external solid state drive, or an internal solid state drive.

The entertainment device 200 may transmit or receive data via one or more data ports 260, such as a USB port, Ethernet® port, WiFi® port, Bluetooth® port or similar, as appropriate. It may also optionally receive data via an optical drive 270.

Interaction with the system is typically provided using one or more handheld controllers 280.

Audio/visual outputs from the entertainment device 200 are typically provided through one or more A/V ports 290, or through one or more of the wired or wireless data ports 260.

Where components are not integrated, they may be connected as appropriate either by a dedicated data link or via a bus 210.

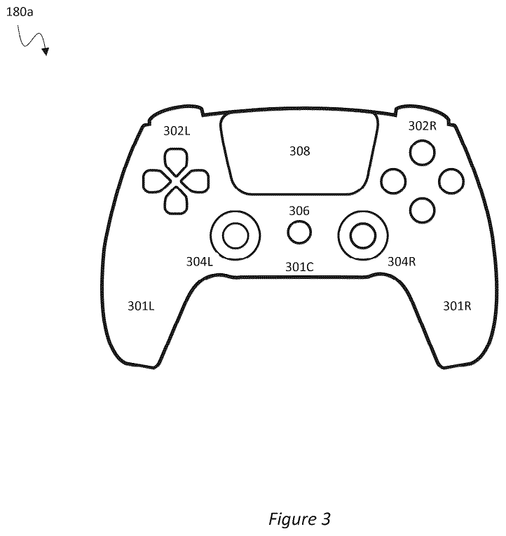

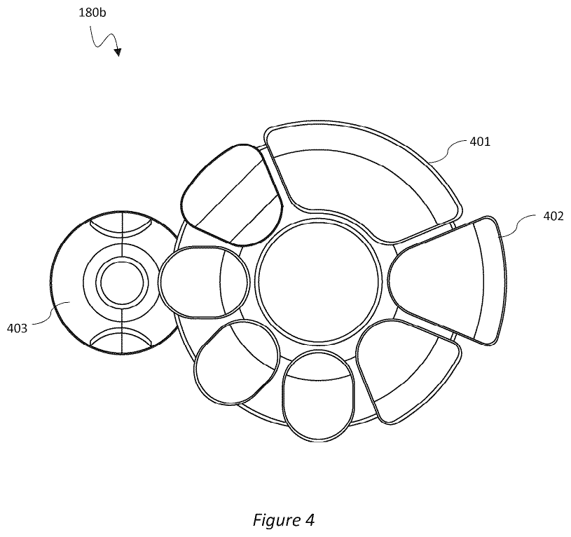

Interaction with the system is typically provided using one or more handheld controllers, and/or one or more VR controllers in the case of the HMD, and/or one or more access controllers 180b, as will be described with reference to FIGS. 3 and 4.

It will be appreciated that the entertainment device 200 is a non-limiting example and that other examples of a game console may include a phone or smart television.

FIG. 3 schematically illustrates a gamepad 180a for interfacing with the game console 105 in accordance with embodiments of the present application. Such a gamepad typically has two handle sections 301L, 301R and a central body 301C. Various controls or input devices are distributed over the gamepad 180a, typically in local groups. Examples include a left button group 302L, which may comprise directional controls and/or one or more shoulder buttons, and similarly right button group 302R, which comprise function controls and/or one or more shoulder buttons. The gamepad also includes left and/or right joysticks 304L, 304R, which may optionally also be operable as buttons by pressing down on them.

The gamepad 180a (typically in the central portion of the device) may also comprise one or more system buttons 306, which typically cause interaction with an operating system of the entertainment device rather than with a game or other application currently running on it; such buttons may summon a system menu, or allow for recording or sharing of displayed content. Furthermore, the gamepad 180a may comprise one or more other elements such as a touchpad 308, a light for optical tracking (not shown), a screen (not shown), haptic feedback elements (not shown), and the like.

FIG. 4 schematically illustrates an access controller 108b for interfacing with the game console 105 in accordance with embodiments of the present application. The access controller 180b is equipped with controls and input devices that provide equivalent functions as those of the gamepad 180a in FIG. 3 but the access controller 180b is designed with a form factor that improves the accessibility of the controller. This may include more accessible layout and input devices such as buttons 401, 402 corresponding to directional controls, function controls, shoulder buttons and system buttons in a gamepad, and control stick 403 in larger size than an ordinary gamepad. The access controller 180b can be placed on a flat surface so that the player is not required to hold the access controller 180b by hand while operating. Furthermore, the layout of the controls and input devices on the access controller 180b can be customized by the player, such as by swapping the buttons or changing the control stick caps. In addition, the control stick may be provided with an extension arm of adjustable length. Furthermore, more than one access controllers 180b can be connected to the video game console 105, or can be combined with other type of game controllers to allow the player to customise the way of playing. As such, the access controller 180b can provide a more versatile, customisable and accessible game controller to meet the control needs of players of all abilities.

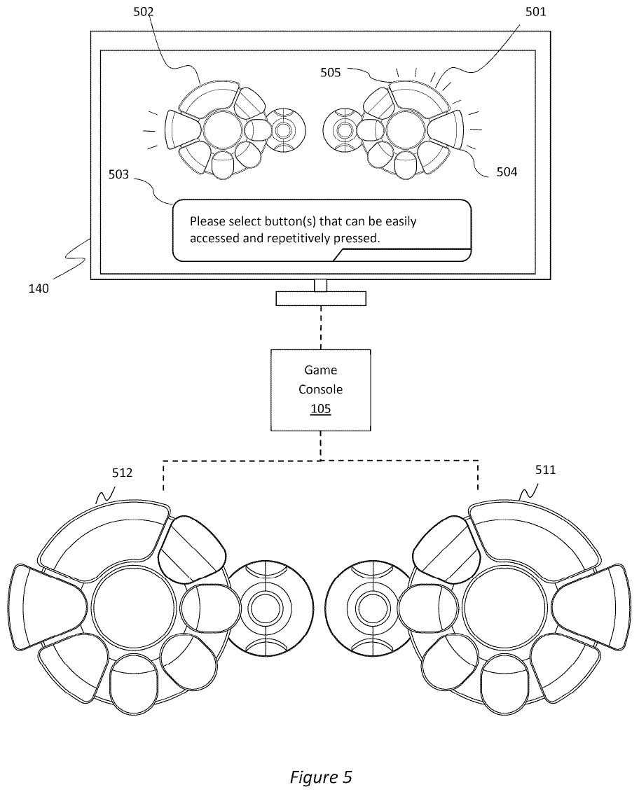

FIG. 5 illustrates an example scenario of providing a user interface for configuring the accessibility constraints of a controller in accordance with embodiments of the present application. The example scenario describes the display device 140 showing a configuration screen generated by the game console 105, in which images 501, 502 correspond to the game controllers 511, 512 connected to the game console 105 are displayed. The configuration screen further displays instructions 503 to prompt the user to select controls or input devices that can be assessed with various levels of difficulty. For example, the user may firstly be asked to select controls or input devices that can be assessed most easily and activated repetitively. Next, the instruction will invite the user to select controls or input devices that can be assessed with ease but repetitive operations cannot be performed. Finally, the user needs to tell the system the controls or input devices that are difficult to access. The system also assumes those controls or input devices not selected throughout the configuration process are impossible to be accessed by the user, and shall be ruled out from any potential control schemes. The information of the accessibility constraints may be stored in a user profile file in the game console 105, for example in the SSD 250. In such a way, the game console may store accessibility constraints of different users by saving them in multiple user profile files.

Optionally or additionally, the configuration screen highlights controls or input devices 504, 505 that have been selected by the user, for example, by flashing the image of the controls or input devices 504, 505 shown on the screen. Furthermore, the image of the controls or input devices 504, 505 may be highlighted in difficult colours to reflect the levels of accessibility. For instances, green colour may be used to represent controls or input devices that can be assessed most easily and activated repetitively; yellow colour may be used to represent controls or input devices that can be assessed with ease but repetitive operations cannot be performed; and red colour may be used to represent controls or input devices that can be accessed but with some difficulties.

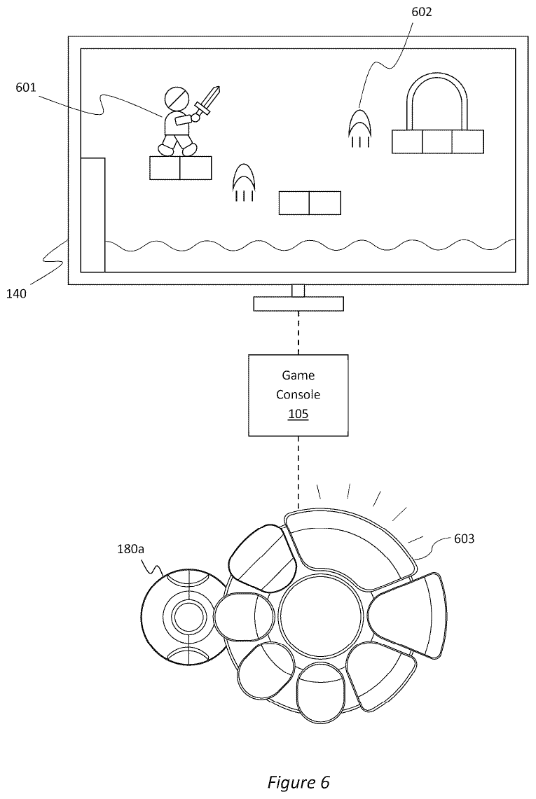

FIG. 6 illustrates an example scenario of providing an optimized control scheme for a game controller in accordance with embodiments of the present application. The example scenario describes the display device 140 showing a video game environment generated by the game console 105, in which the player character 601 encounters certain game events, such as enemies and traps 602 while exploring a dungeon. The gameplay requires repetitive activation of game commands such as the “attack” command or “jump” command. With the optimized control scheme that assigns these high usage game commands to most accessible controls or input devices on the access controller 180b, the player with accessibility needs is allowed to operate the controls or input devices, thereby playing the game with greater comfort and ease. Optionally or additionally, the game console 105 generates a visual feedback on the access controller 180b by lighting up the light emitting elements associated with the function button 603 pressed by the player. As such, the user can receive feedback and acknowledgment of performing an operation on a corresponding input device of the game controller 180a in a way that feels more natural and intuitive. Accordingly, a more engaging and immersive gaming experience can be provided.

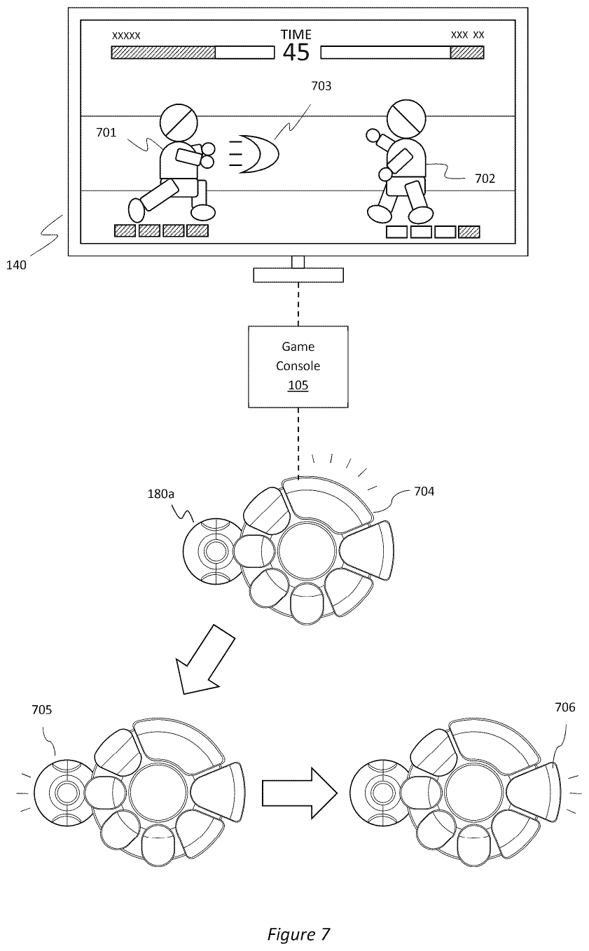

FIG. 7 illustrates another example scenario of providing an optimized control scheme for a game controller in accordance with embodiments of the present application. The example scenario describes the display device 140 showing a video game environment generated by the game console 105, in which a player character 701 is combating in a one-on-one match against an opponent 702. The player character 701 has certain special abilities that are activated by inputting a sequence and/or combination (simultaneous operation) of game commands. For example, a “super move” which results in a much stronger attack 703 with special effect can be performed by pressing button 704, followed by tilting the control stick 705 to the left, and finally pressing button 706. With the optimized control scheme that assigns the various commands of the sequence or combination of game commands to the most accessible controls that are closely arranged on the access controller 180b, the player is allowed to perform the sequence and/or combination of control or input device operations in an easier, faster, more accurate and more comfortable manner, thereby providing enjoyable gaming experiences to players of all abilities. Optionally or additionally, the game console 105 generates a visual feedback on the access controller 180b in response to an operation performed on the associated input device of the access controller 180b. For example, an embedded LED of a push button or control stick 704, 705, 706 will light up when the corresponding push button 704, 706 is pressed or the control stick 705 is tilted. Accordingly, a more engaging and immersive gaming experience can be provided.

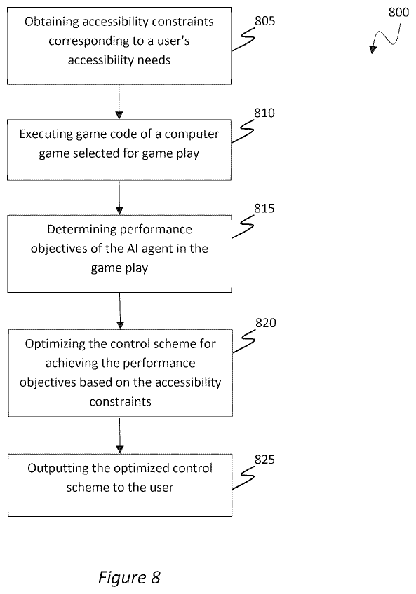

FIG. 8 shows a schematic flow diagram describing a computerized process 800 for optimizing a control scheme of a game controller in accordance with embodiments of the present application. Process 800 may begin at step 805, where the system performs a “calibration” procedure to work out the appropriate constraints a control configuration used by the user must conform to. The user interface may invite the user to classify each control into different levels with respect to accessibility. In some embodiments, the user may firstly be asked to select controls or input devices that can be assessed most easily and activated repetitively. Next, the instruction will invite the user to select controls or input devices that can be assessed with ease but repetitive operations cannot be performed. Finally, the user needs to tell the system the controls or input devices that are difficult to access. The system also assumes those controls or input devices not selected throughout the configuration process are impossible to be accessed by the user, and shall be ruled out from any potential control schemes.

The process then moves to step 810 where the game console executes game code of a computer game selected for game play.

During the game development stage, a model for artificial intelligence agent is designed, for example, using multiple layers of neural network. The use of neural networks allows predicting value for actions to be taken by the AI agent in a given game state.

One or more example embodiments of the present technique may use reinforcement learning (RL) systems and technique to train the model of AI agent to play the particular computer game until the AI agent is able to finish the game like an average human player.

Reinforcement learning is a type of machine learning directed to training an artificial intelligence agent to take actions in an environment that maximize the notion of a cumulative reward. During reinforcement learning, the agent interacts with the environment, and learns from the results of its actions, thus allowing the agent to progressively improve its decision-making.

An RL model typically comprises an action-reward feedback loop. The feedback loop comprises: an environment, state, agent, policy, action, and reward. The environment is the system with which the agent interacts and in which the agent operates—for example, the environment may be a virtual environment of a game. The state represents the current conditions in the environment. The agent receives the state as an input and takes an action which may affect the environment and change the state of the environment. The agent takes the action based on its policy which is a mapping from states of the environment to actions of the agent. The policy may be deterministic or stochastic. The reward represents feedback from the environment to the action taken by the agent. The reward provides an indication (typically in the form of a numerical value) of the desirability of the result of the agent's action. The reward may comprise positive signals to reward desirable behaviour of the agent and/or negative signals to penalize undesirable behaviour of the agent.

Through multiple iterations of action-reward feedback loop, the agent aims to maximise the total cumulative reward it receives, thus learning how to take optimal actions in the environment. The reinforcement learning process thus allows the agent to learn an optimal policy that maximizes the cumulative reward. The cumulative award may be estimated using a value function which estimates the expected return starting from a given state or from a given state and action. Using the cumulative reward in the reinforcement learning process allows the agent to consider long-term effects of its policy.

A reinforcement learning algorithm may be used to refine the agent's policy and the value function over iterations of the action-reward feedback loop. The learning algorithm may rely on a model of the environment (e.g. based on Markov Decision Processes (MDPs)) or be model-free. Example suitable model-free reinforcement learning algorithms include Q-learning, SARSA (State-Action-Reward-State-Action), Deep Q-Networks (DQNs), or Deep Deterministic Policy Gradient (DDPG).

It will be appreciated that the agent will typically engage in both exploration and exploitation of the environment in which it operates. In exploration, the agent takes typically random actions to gather information about the environment and identify potentially desirable actions (i.e. actions that maximise cumulative reward). In exploitation, the agent takes actions that are expected to maximise reward (e.g. by selecting the action based on the agent's latest policy). Various techniques may be used to control the proportion of explorative and exploitative actions taken by the agent—for example, a predetermined probability of taking an explorative action in a given iteration of the feedback loop may be set (and optionally reduced over time to allow the agent to shifts more towards exploitation over time to maximise cumulative reward in view of diminishing returns for further exploration).

During the training, the agent plays the game by taking actions through the player commands to interact with the game environment created by execution of game code. For example, in a first person shooting (FPS) game, the actions taken by the agent includes using weapons and items, executing special skills, dodging attacks, and exploring the game world. In a car racing game, the actions taken by the agent includes steering, accelerate, brake, reverse, gear up and down commands. The reinforcement learning algorithm learns the policy by trial and error, i.e. decision about what actions to take in order to play the game and maximize the reward. The rewards for the actions it performs include game score, successful completion of game levels, experience points, and time spent on finishing the game. The penalties for the actions include damage received or health point loss, life loss, extra time spent on finishing the game.

In some embodiments, the training of the model of AI agent may involve only sample portions of the game, instead of the full game. For example, certain typical game scenarios, levels or episodes, which require player skills for playing the game in general, can be selected for training the model of AI agent to reduce the training time.

The process then proceeds to step 815 where the performance objectives are determined for the AI agent in the game play. In some embodiments, a performance score may be evaluated for each control scheme, reflecting the performance objectives achieved. Subject to the accessibility constraints, different control schemes (for example, with different assignment of buttons, assignment of button combinations, control sensitivity settings, and steering deadzone settings) are adopted by the agent model to play the game or a portion of the game. The performance of different control schemes are evaluated by measuring the performance objectives, which may include finishing the game (killing a boss character, solving a puzzle, collecting required items, rescuing a game character) with a predetermined game score, and/or within a predetermined time limit. The trained agent model is subsequently used to play the specific game by applying the accessibility constraints.

At step 820, the AI agent plays the game with different candidate control schemes to optimize the control scheme for achieving the performance objectives determined in step 815, conforming to the accessibility constraints obtained in step 805.

The various candidate control schemes can be generated either randomly or by iteration algorithms. As such, an optimal control configuration can be obtained by evaluating the actual usability and utilization of the controls for playing a particular game through extensive playtesting of the AI agent. The iterative testing of the control configuration by the AI agent makes it possible for the system to efficiently design control configurations that provide the best accessibility and gameplay experience. By generating candidate control schemes either randomly or by iteration algorithms, the design of control schemes is no longer limited by the developer or the users' own experiences, and better modified control schemes that the developer or the users haven't been thought of can be discovered.

Different AI agent models may be trained for different characters or play styles (offensive or defensive). Depending on the character or play style chosen by the user, the corresponding AI agent model will be executed to optimize the control scheme.

Similar to the training of the model of AI agent, the evaluation of the candidate control schemes may involve only sample portions of the game, instead of the full game. For example, certain typical game scenarios, levels or episodes, which require player skills for playing the game in general, can be selected for training the model of AI agent to reduce the training time.

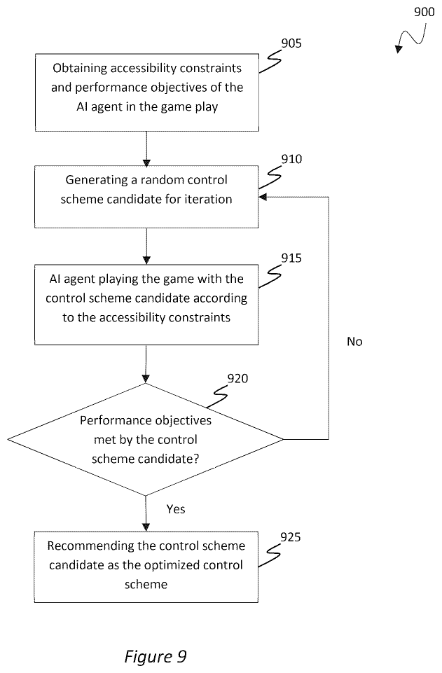

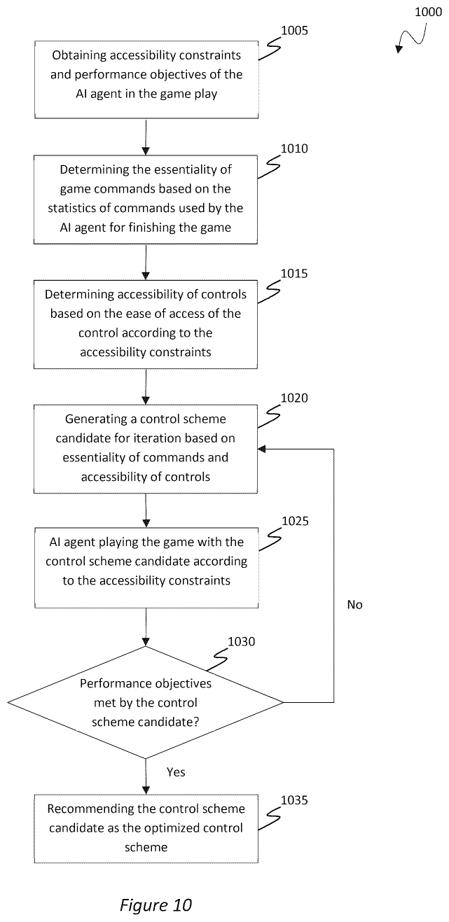

Details of the optimization of control scheme will be described with reference to FIGS. 9 and 10.

At step 825, the system outputs the optimized control scheme to the user. In some embodiments, the system may adopt the optimized control scheme in the game configuration directly. In some embodiments, the system may program the optimized control scheme into the game controller. Optionally or additionally, the system may recommend more than one optimized control scheme, such as control schemes corresponding to different game characters, hence with different special skills and play styles. In some embodiments, the system may recommend multiple optimized control schemes and the user is allowed to choose a control scheme based on personal preference and/or the performance score of each optimized control scheme.

Optionally or additionally, the user may further customize the optimized control scheme based on personal preference. To assist the user in making a decision to customize a control scheme, the system may execute the AI agent to play the game or a portion of the game in order to test the performance of a control scheme customized by the user. For example, the system may compare the performance of the customized control scheme against other control schemes by evaluating a new performance score for the customized control scheme.

As such, the customized control configuration can be evaluated and adjusted in terms of the actual usability and utilization of the controls for playing a particular game through extensive playtesting of the AI agent. The iterative testing of the customized control configuration by the AI agent also enables the user to efficiently optimize the customized control configuration which further improves accessibility and gameplay experience.

FIG. 9 shows a schematic flow diagram describing an optimization process in the method of optimizing a control scheme of a game controller in FIG. 8 in accordance with embodiments of the present application. Process 900 may begin at step 905, where the system obtains accessibility constraints and performance objectives of the AI agent in the game play.

The process then moves to step 910 where the system generating a random candidate control scheme for iteration. In some embodiments, the candidate control schemes are generated randomly and condition on the accessibility constraints. For example, if the accessibility constraints restrict the use of certain buttons because they are difficult for the user to access, then the candidate control schemes generated will not assign commands to these buttons.

At step 915, the AI agent plays the game with the candidate control scheme according to the accessibility constraints. The process then proceeds to step 920 where the system accesses the performance of the current candidate control scheme. In the event that the performance objectives obtained in step 905 is met by the candidate control scheme, the process moves to step 925 where the system recommends the current candidate control scheme as the optimized control scheme.

Returning to step 920, in the event that the candidate control scheme does not meet the performance objectives, for example, the AI agent fails to complete the game or achieve a predetermined game score, the process moves to step 910 where another candidate control scheme is generated. In some embodiments, the trial and error process ends when the number of iterations exceeds a predetermined threshold. The process then moves to step 925 where the system recommends the candidate control scheme that achieves the best performance score.

In some embodiments, reinforcement learning systems and technique as described previously herein can be used to optimize the control configuration. The RL model may comprise an action-reward feedback loop that includes the control scheme and reward. The reward may represent the performance achieved by the AI agent, such as game score, successful completion of game levels, experience points, and time spent on finishing the game, when playing the game using the relevant control scheme under the accessibility constraint. Through multiple iterations of action-reward feedback loop, the agent aims to maximise the total cumulative reward it receives, thus learning the optimal control configuration.

FIG. 10 shows a schematic flow diagram describing another optimization process in the method of optimizing a control scheme of a game controller in FIG. 8 in accordance with embodiments of the present application. Process 1000 may begin at step 1005, where the system obtains accessibility constraints and performance objectives of the AI agent in the game play.

The process then moves to step 1010 where the system determines the essentiality of each game command based on the statistics of commands used (such as frequency distribution of individual commands and command sequences/combinations, amount of repetitive operations) by the AI agent for finishing the game without applying the accessibility constraints.

At step 1015, the system further determines the accessibility of each control by classifying the control based on the ease of access of the control by the user according to the accessibility constraints.

At step 1020, the system generates candidate control schemes by iteration based on the essentiality of commands and the accessibility constraints. For example, the group of most essential commands are mapped to the group of most accessible controls according to the accessibility constraints, and similarly, the group of least essential commands are mapped to the group of least accessible controls. As such, the optimization process can be expedited comparing to adopting randomly generated candidate control schemes without considering the essentiality of the commands in the game. In addition, if the accessibility constraints restrict the use of certain buttons because they are difficult for the user to access, then the candidate control schemes generated will not assign commands to these buttons.

In some embodiments, the system generates candidate control schemes by iteration algorithms. For example, the trends of performance given by previous candidate control schemes are taken into account when generating the next candidate control scheme attempting to further improve the performance.

At step 1025, the AI agent plays the game with the candidate control scheme according to the accessibility constraints. The process then proceeds to step 1030 where the system accesses the performance of the current candidate control scheme. In the event that the performance objectives obtained in step 1005 is met by the candidate control scheme, the process moves to step 1035 where the system recommends the current candidate control scheme as the optimized control scheme.

Returning to step 1030, in the event that the candidate control scheme does not meet the performance objectives, for example, the AI agent fails to complete the game or achieve a predetermined game score, the process moves to step 1020 where another candidate control scheme is generated. In some embodiments, the trial and error process ends when the number of iterations exceeds a predetermined threshold. The process then moves to step 1035 where the system recommends the candidate control scheme that achieves the best performance score.

Variations in the systems, methods and techniques herein may also be contemplated.

For example, rather than inviting the user to classify each control into different levels with respect to accessibility during the “calibration” procedure, the system can determine the accessibility constraints by inviting the user to activate a sequence of commands through the plurality of controls on the game controller. For example, the system may ask the user to perform a sequence of steps including operating a joystick in various directions, and pressing various buttons. The system may measure the time lapse or delay for the activation of a command in order to determine the accessibility constraints with respect to the relevant control.

Furthermore, the system may include a database containing information of various types of physical illness or disability, and the corresponding accessibility constraints for operating the controls of the game controller. For example, if a user is only able to play games with his or her right hand, the accessibility constraints in the database will indicate the controls of the right hand side of a game controller as easily accessible, and the controls of the left hand side as difficult or impossible to access. As such, the user only needs to enter the type of physical illness or disability during the “calibration” procedure, and the system can determine the corresponding accessibility constraints by looking up the database.

It will be appreciated that the above methods may be carried out on conventional hardware suitably adapted as applicable by software instruction (e.g. game console 105) or by the inclusion or substitution of dedicated hardware.

Thus the required adaptation to existing parts of a conventional equivalent device may be implemented in the form of a computer program product comprising processor implementable instructions stored on a non-transitory machine-readable medium such as a floppy disk, optical disk, hard disk, solid state disk, PROM, RAM, flash memory or any combination of these or other storage media, or realised in hardware as an ASIC (application specific integrated circuit) or an FPGA (field programmable gate array) or other configurable circuit suitable to use in adapting the conventional equivalent device. Separately, such a computer program may be transmitted via data signals on a network such as an Ethernet, a wireless network, the Internet, or any combination of these or other networks.

Hence in a summary embodiment of the present description, an information processing apparatus comprises the following.

Firstly, an interface module (e.g.: game logic 110) is configured (for example by suitable software instruction) to determine accessibility constraints corresponding to a user's accessibility needs, as described elsewhere herein.

Secondly, an artificial intelligence module (e.g.: game logic 110) is configured (for example by suitable software instruction) to operate an artificial intelligence agent to play a computer game based on a plurality of candidate control schemes and conforming to the accessibility constraints, as described elsewhere herein.

Thirdly, a control module (e.g.: game logic 110) is configured (for example by suitable software instruction) to determine the candidate control scheme that achieves a predetermined performance objective as an optimized control scheme.

It will be apparent to a person skilled in the art that variations in the above system corresponding to the various embodiments of the method as described and claimed herein are considered within the scope of the present technique, including but not limited to that:
In an instance of the summary embodiment, the accessibility constraints is selected from the group consisting of: delay in activating a control means, capability of activating a control means, limitations of using at least one of the user's fingers, and amount time between repetitions of activating a control means, as described elsewhere herein;
In an instance of the summary embodiment, the accessibility constraints are determined by inviting the user to activate a sequence of commands through the plurality of controls on the game controller, as described elsewhere herein;
In an instance of the summary embodiment, the accessibility constraints are determined based on illness or disability information obtained from the user, as described elsewhere herein;
In an instance of the summary embodiment, the performance objective is selected from the group consisting of: predetermined game score threshold, maximising a game score, a predetermined game finishing time threshold, and minimizing game finishing time, a predetermined threshold corresponding to health point loss of a game character, and minimizing health point loss of a game character, as described elsewhere herein;
In an instance of the summary embodiment, the control scheme includes assignment of buttons, assignment of button combinations, control sensitivity settings, and steering deadzone settings, as described elsewhere herein;
In an instance of the summary embodiment, the optimizing the control scheme is performed at developer level, as described elsewhere herein;
In an instance of the summary embodiment, the optimizing the control scheme is performed at end-user level, as described elsewhere herein;
In an instance of the summary embodiment, the candidate control schemes are generated randomly, as described elsewhere herein;
In an instance of the summary embodiment, the candidate control schemes are generated by iteration, as described elsewhere herein;
In an instance of the summary embodiment, the method further comprises the step of determining the optimal control scheme from the candidate control schemes by reinforcement learning, as described elsewhere herein;
In an instance of the summary embodiment, the method further comprises the steps of: determining essentiality of commands, and performing the control scheme iteration based on the essentiality of commands and the accessibility constraints, as described elsewhere herein;
In an instance of the summary embodiment, the essentiality of a command is determined by classifying the command based on the statistics of the command used by the artificial intelligence agent in the game play, as described elsewhere herein;
In an instance of the summary embodiment, the method further comprises the step of outputting the optimized control scheme to the user for customization, as described elsewhere herein.

Example(s) of the present technique are defined by the following numbered clauses:

1. A method for optimizing a control scheme of a game controller including a plurality of controls, said method comprising the steps of: determining accessibility constraints corresponding to a user's accessibility needs; operating an artificial intelligence agent to play a computer game based on a plurality of candidate control schemes and conforming to the accessibility constraints; and determining the candidate control scheme that achieves a predetermined performance objective as an optimized control scheme.
2. The method of optimizing a control scheme according to clause 1, wherein the accessibility constraints is selected from the group consisting of: delay in activating a control means, capability of activating a control means, limitations of using at least one of the user's fingers, and amount time between repetitions of activating a control means.
3. The method of optimizing a control scheme according to clause 1, wherein the accessibility constraints are determined by inviting the user to activate a sequence of commands through the plurality of controls on the game controller.
4. The method of optimizing a control scheme according to clause 1, wherein the accessibility constraints are determined based on illness or disability information obtained from the user.
5. The method of optimizing a control scheme according to clause 1, wherein the performance objective is selected from the group consisting of: predetermined game score threshold, maximising a game score, a predetermined game finishing time threshold, and minimizing game finishing time, a predetermined threshold corresponding to health point loss of a game character, and minimizing health point loss of a game character.
6. The method of optimizing a control scheme according to clause 1, wherein the control scheme includes assignment of buttons, assignment of button combinations, control sensitivity settings, and steering deadzone settings.
7. The method of optimizing a control scheme according to clause 1, wherein the optimizing the control scheme is performed at developer level.
8. The method of optimizing a control scheme according to clause 1, wherein the optimizing the control scheme is performed at end-user level.
9. The method of optimizing a control scheme according to clause 1, wherein the candidate control schemes are generated randomly.
10. The method of optimizing a control scheme according to clause 1, wherein the candidate control schemes are generated by iteration.
11. The method of optimizing a control scheme according to clause 1, further comprising the step of determining the optimal control scheme from the candidate control schemes by reinforcement learning.
12. The method of optimizing a control scheme according to clause 1, further comprising the steps of: determining essentiality of commands, and performing the control scheme iteration based on the essentiality of commands and the accessibility constraints.
13. The method of optimizing a control scheme according to clause 12, wherein the essentiality of a command is determined by classifying the command based on the statistics of the command used by the artificial intelligence agent in the game play.
14. The method of optimizing a control scheme according to clause 1, further comprising the step of outputting the optimized control scheme to the user for customization.
15. A computer program comprising computer executable instructions adapted to cause a computer system to perform the method of any one of the preceding clauses.
16. An information processing apparatus for optimizing a control scheme of a game controller including a plurality of controls, the information processing apparatus comprising circuitry configured to: determine accessibility constraints corresponding to a user's accessibility needs; operate an artificial intelligence agent to play a computer game based on a plurality of candidate control schemes and conforming to the accessibility constraints; and determine the candidate control scheme that achieves a predetermined performance objective as an optimized control scheme.
17. The information processing apparatus for optimizing a control scheme of a game controller according to clause 16, wherein the accessibility constraints is selected from the group consisting of: delay in activating a control means, capability of activating a control means, limitations of using at least one of the user's fingers, and amount time between repetitions of activating a control means.
18. The information processing apparatus for optimizing a control scheme of a game controller according to clause 16, wherein the accessibility constraints are determined by inviting the user to activate a sequence of commands through the plurality of controls on the game controller.
19. The information processing apparatus for optimizing a control scheme of a game controller according to clause 16, wherein the accessibility constraints are determined based on illness or disability information obtained from the user.
20. The information processing apparatus for optimizing a control scheme of a game controller according to clause 16, wherein the performance objective is selected from the group consisting of: predetermined game score threshold, maximising a game score, a predetermined game finishing time threshold, and minimizing game finishing time, a predetermined threshold corresponding to health point loss of a game character, and minimizing health point loss of a game character.
21. The information processing apparatus for optimizing a control scheme of a game controller according to clause 16, wherein the control scheme includes assignment of buttons, assignment of button combinations, control sensitivity settings, and steering deadzone settings.
22. The information processing apparatus for optimizing a control scheme of a game controller according to clause 16, wherein the optimizing the control scheme is performed at developer level.
23. The information processing apparatus for optimizing a control scheme of a game controller according to clause 16, wherein the optimizing the control scheme is performed at end-user level.
24. The information processing apparatus for optimizing a control scheme of a game controller according to clause 16, wherein the candidate control schemes are generated randomly.
25. The information processing apparatus for optimizing a control scheme of a game controller according to clause 16, wherein the candidate control schemes are generated by iteration.
26. The information processing apparatus for optimizing a control scheme of a game controller according to clause 16, wherein the circuitry is configured to determine the optimal control scheme from the candidate control schemes by reinforcement learning.
27. The information processing apparatus for optimizing a control scheme of a game controller according to clause 16, wherein the circuitry is configured to: determine essentiality of commands, and perform the control scheme iteration based on the essentiality of commands and the accessibility constraints.
28. The information processing apparatus for optimizing a control scheme of a game controller according to clause 27, wherein the essentiality of a command is determined by classifying the command based on the statistics of the command used by the artificial intelligence agent in the game play.
29. The information processing apparatus for optimizing a control scheme of a game controller according to clause 16, wherein the circuitry is configured to output the optimized control scheme to the user for customization.

The foregoing discussion discloses and describes merely exemplary embodiments of the present technique. As will be understood by those skilled in the art, the present technique may be embodied in other specific forms without departing from the spirit or essential characteristics thereof. Accordingly, the disclosure of the present technique is intended to be illustrative, but not limiting of the scope of the technique, as well as other claims. The disclosure, including any readily discernible variants of the teachings herein, defines, in part, the scope of the foregoing claim terminology such that no inventive subject matter is dedicated to the public.

1. A method for optimizing a control scheme of a game controller including a plurality of controls, said method comprising the steps of:
determining accessibility constraints corresponding to a user's accessibility needs;
operating an artificial intelligence agent to play a computer game based on a plurality of candidate control schemes and conforming to the accessibility constraints; and
determining the candidate control scheme that achieves a predetermined performance objective as an optimized control scheme.

2. The method of optimizing a control scheme according to claim 1, wherein the accessibility constraints is selected from the group consisting of: delay in activating a control means, capability of activating a control means, limitations of using at least one of the user's fingers, and amount time between repetitions of activating a control means.

3. The method of optimizing a control scheme according to claim 1, wherein the accessibility constraints are determined by inviting the user to activate a sequence of commands through the plurality of controls on the game controller.

4. The method of optimizing a control scheme according to claim 1, wherein the accessibility constraints are determined based on illness or disability information obtained from the user.

5. The method of optimizing a control scheme according to claim 1, wherein the performance objective is selected from the group consisting of: predetermined game score threshold, maximising a game score, a predetermined game finishing time threshold, and minimizing game finishing time, a predetermined threshold corresponding to health point loss of a game character, and minimizing health point loss of a game character.

6. The method of optimizing a control scheme according to claim 1, wherein the control scheme includes assignment of buttons, assignment of button combinations, control sensitivity settings, and steering deadzone settings.

7. The method of optimizing a control scheme according to claim 1, wherein the optimizing the control scheme is performed at developer level.

8. The method of optimizing a control scheme according to claim 1, wherein the optimizing the control scheme is performed at end-user level.

9. The method of optimizing a control scheme according to claim 1, wherein the candidate control schemes are generated randomly.

10. The method of optimizing a control scheme according to claim 1, wherein the candidate control schemes are generated by iteration.

11. The method of optimizing a control scheme according to claim 1, further comprising the step of determining the optimal control scheme from the candidate control schemes by reinforcement learning.

12. The method of optimizing a control scheme according to claim 1, further comprising the steps of:
determining essentiality of commands, and
performing the control scheme iteration based on the essentiality of commands and the accessibility constraints.

13. The method of optimizing a control scheme according to claim 12, wherein the essentiality of a command is determined by classifying the command based on the statistics of the command used by the artificial intelligence agent in the game play.

14. The method of optimizing a control scheme according to claim 1, further comprising the step of outputting the optimized control scheme to the user for customization.

15. A non-transitory computer-readable storage medium storing a computer program comprising computer executable instructions adapted to cause a computer to perform a method for optimizing a control scheme of a game controller including a plurality of controls, said method comprising the steps of:
determining accessibility constraints corresponding to a user's accessibility needs;
operating an artificial intelligence agent to play a computer game based on a plurality of candidate control schemes and conforming to the accessibility constraints; and
determining the candidate control scheme that achieves a predetermined performance objective as an optimized control scheme.

16. An information processing apparatus for optimizing a control scheme of a game controller including a plurality of controls, the information processing apparatus comprising circuitry configured to:
determine accessibility constraints corresponding to a user's accessibility needs;
operate an artificial intelligence agent to play a computer game based on a plurality of candidate control schemes and conforming to the accessibility constraints; and
determine the candidate control scheme that achieves a predetermined performance objective as an optimized control scheme.

17. The information processing apparatus for optimizing a control scheme of a game controller according to claim 16, wherein the accessibility constraints is selected from the group consisting of: delay in activating a control means, capability of activating a control means, limitations of using at least one of the user's fingers, and amount time between repetitions of activating a control means.

18. The information processing apparatus for optimizing a control scheme of a game controller according to claim 16, wherein the accessibility constraints are determined by inviting the user to activate a sequence of commands through the plurality of controls on the game controller.

19. The information processing apparatus for optimizing a control scheme of a game controller according to claim 16, wherein the accessibility constraints are determined based on illness or disability information obtained from the user.

20. The information processing apparatus for optimizing a control scheme of a game controller according to claim 16, wherein the performance objective is selected from the group consisting of: predetermined game score threshold, maximising a game score, a predetermined game finishing time threshold, and minimizing game finishing time, a predetermined threshold corresponding to health point loss of a game character, and minimizing health point loss of a game character.
